(19) United States
(12) Patent Application Publication
(10) Pub. No.: US 2006/0150732 A1
(43) Pub. Date: Jul. 13, 2006

(54) Gyro sensor

(75) Inventors: Teruo Mori, Tokyo (JP); Toshio Chamura, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/547,333

(22) PCT Filed: Mar. 12, 2004
(86) PCT No.: PCT/JP04/03371

§ 371 Date: Sep. 1, 2005

(30) Foreign Application Priority Data
Mar. 31, 2003 (JP) 2003-094845

(51) Int. Cl. G01P 9/04; G01P 3/44

(52) U.S. Cl. 73/504.12; 73/514.39

(57) ABSTRACT

A gyro sensor 10 having a small and simple structure and yet being capable of detecting changes in angular speed with high sensitivity. The sensor 10 includes a giant magnetostrictive member 12 made of a giant magnetostrictive element, a drive coil 18 for vibrating the giant magnetostrictive member 12 by controlling the intensity of a magnetic field applied to the giant magnetostrictive member, and a GMR element (detecting means) 20 for detecting changes in magnetic permeability or remnant magnetization of the giant magnetostrictive member 12. Changes in angular speed around a rotation axis that is orthogonal to a direction in which the giant magnetostrictive member 12 vibrates are detected as the changes in magnetic permeability or remnant magnetization of the giant magnetostrictive member 12 caused by its deformation, which is brought about by the Coriolis force.

### TECHNICAL FIELD

The present invention relates to a gyro sensor applied for correcting hand held camera shake of video cameras, or in navigation systems of automobiles, or the like.

### BACKGROUND ART

Conventionally, gyro sensors utilizing a dynamic phenomenon that an angular speed applied to a vibrating object causes generation of the Coriolis force in a direction orthogonal to the direction of vibration are widely known (see, for example, Japanese Patent Laid-Open Publication No. 2000-136933). The Coriolis force F is given by the equation F=2 mvω (m: mass of vibrating object; v: vibration speed; ω: angular speed), and conventional gyro sensors detect changes in the angular speed ω based on the Coriolis force F.

Small and high-sensitivity gyro sensors are demanded recently in this field.

However, to enhance the detection sensitivity of angular speed changes (to increase the Coriolis force F), it is generally necessary to increase the vibration amplitude or the mass of the vibrating object, and therefore, with conventionally known gyro sensors, size reduction was limited.

### DISCLOSURE OF THE INVENTION

The present invention was devised to solve these problems and its object is to provide a gyro sensor which has a small and simple structure and yet is capable of detecting changes in angular speed with improved sensitivity.

Through research, the inventor of the present invention has devised a gyro sensor which has a small and simple structure and yet is capable of detecting changes in angular speed with improved sensitivity, in which angular speed changes are detected as changes in magnetic permeability or remnant magnetization of a magnetostrictive member caused by its deformation, which is brought about by the Coriolis force.

In summary, the above-described objectives are achieved by the following aspects of the present invention.

(1) A gyro sensor characterized by comprising: a magnetostrictive member made of a magnetostrictive element; a drive coil for vibrating the magnetostrictive member by controlling the intensity of a magnetic field applied to the magnetostrictive member; and detecting means for detecting changes in magnetic permeability or remnant magnetization of the magnetostrictive member, wherein changes in angular speed around a rotation axis that is orthogonal to a direction in which the magnetostrictive member vibrates are detected as changes in magnetic permeability or remnant magnetization of the magnetostrictive member caused by deformation thereof, which is brought about by the Coriolis force.

(2) The gyro sensor according to (1), wherein the drive coil vibrates the magnetostrictive member at a resonant frequency.

(3) The gyro sensor according to (1) or (2), wherein: the detecting means includes a magnetic resistance element; and the changes in magnetic permeability or remnant magnetization are detected as changes in electromotive force of the magnetic resistance element.

(4) The gyro sensor according to (1) or (2), wherein; the detecting means includes a detection coil surrounding the magnetostrictive member; and the changes in magnetic permeability or remnant magnetization are detected as changes in inductance of the detection coil.

(5) The gyro sensor according to any one of (1) to (4), wherein: a magnetic biasing magnet is tightly attached to one side of the magnetostrictive member; and a soft magnetic member around which the drive coil is disposed is tightly attached to an opposite side of the magnetostrictive member.

(6) The gyro sensor according to any one of (1) to (5), wherein the magnetostrictive member is a giant magnetostrictive member made of a giant magnetostrictive element.

### BRIEF DESCRIPTION OF THE DRAWINGS

FIG. 1 is a schematic perspective view showing a gyro sensor according to one exemplary embodiment of the present invention;

FIG. 2 is a diagram illustrating the operation principle of the gyro sensor of FIG. 1; and

FIG. 3 is a schematic perspective view illustrating a gyro sensor according to another exemplary embodiment of the present invention.

### BEST MODE FOR CARRYING OUT THE INVENTION

Exemplary embodiments of the present invention will be hereinafter described with reference to the drawings.

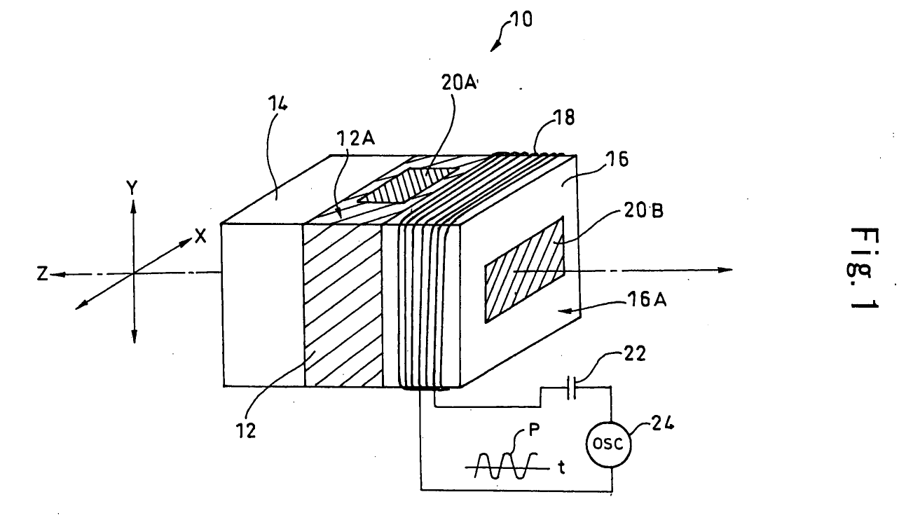

As shown in FIG. 1, a gyro sensor 10 according to one exemplary embodiment of the present invention is made up of a giant magnetostrictive member 12 disposed in the center of the drawing and formed of a substantially parallelepiped member, a biasing magnet 14 disposed on the left side of this giant magnetostrictive member 12, a soft magnetic member 16 disposed on the right side of the giant magnetostrictive member 12, a drive coil 18 disposed to surround this soft magnetic member 16, and GMR elements (detecting means) 20A and 20B respectively provided on the top face 12A of the giant magnetostrictive member 12 and on a side face 16A of the soft magnetic member 16.

The biasing magnet 14, which is a magnetic material, and the soft magnetic member 16 are tightly attached to both sides of the giant magnetostrictive member 12 located in the center of the drawing. To the drive coil 18 disposed to surround the soft magnetic member 16 is connected a pulse oscillator 24, which is the drive power supply source of the giant magnetostrictive member 12, via a capacitor 22. Thus, not only a magnetic field of the biasing magnet 14 that is applied in the direction denoted at Z in the drawing, but an alternating magnetic field can also be applied by the drive coil 18 to the giant magnetostrictive member 12.

The giant magnetostrictive member 12 is made of a giant magnetostrictive element. The “giant magnetostrictive element” shall refer to a magnetostrictive element made from powder sintered alloy or single-crystal alloy that is mainly composed of a rare-earth element and/or specified transition metal (for example, terbium, dysprosium, iron and the like), and this giant magnetostrictive element has a characteristic that its magnetic susceptibility changes largely when the element is deformed by an external stress. The GMR elements 20A and 20B respectively provided on the top face 12A of the giant magnetostrictive member 12 and on the side face 16A of the soft magnetic member 16 can detect changes in the magnetic permeability or remnant magnetization of the giant magnetostrictive member 12 caused by such deformation (extension and contraction) as changes in the electromotive force.

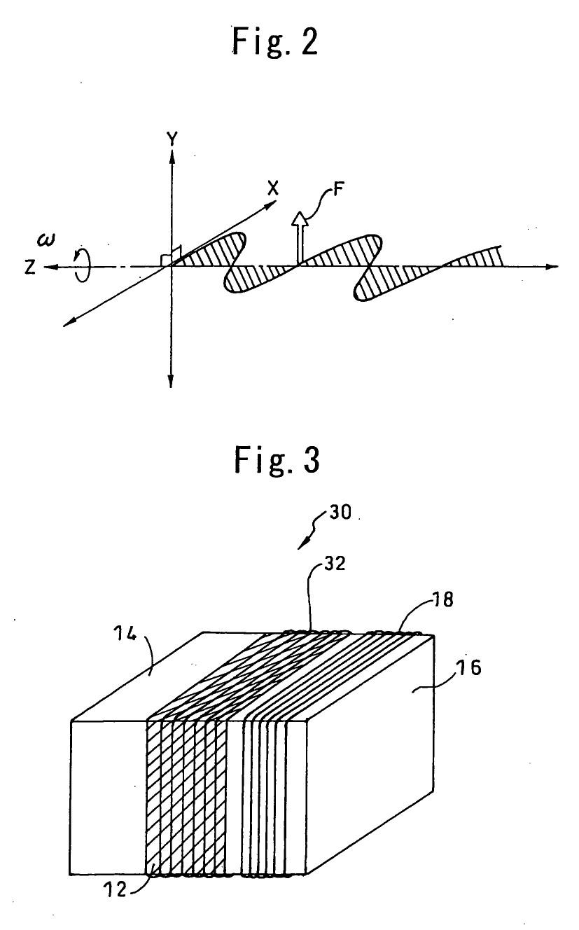

Next, the operation of the gyro sensor 10 is described with reference also to FIG. 2.

When a pulse signal P is supplied from the pulse oscillator 24 to the drive coil 18, the intensity of the alternating magnetic field applied to the giant magnetostrictive member 12 changes in accordance with the frequency of the pulse signal P. As a result, the giant magnetostrictive member 12 vibrates (extends and contracts) at the same frequency as the pulse signal P due to the magnetostrictive effect. More specifically, when the giant magnetostrictive member 12 extends in the Z direction, it contracts in the X and Y directions, and, when the giant magnetostrictive member 12 contracts in the Z direction, it extends in the X and Y directions. The giant magnetostrictive member 12 thus repeats extension and contraction in the X, Y, and Z directions. In this example, the pulse signal P is a signal having. a resonant frequency of the giant magnetostrictive member 12 so that the giant magnetostrictive member 12 vibrates at this frequency.

Next, suppose a case where the vibrating giant magnetostrictive member 12 is rotated around an axis that extends in the Z direction at an angular speed of ω). When the giant magnetostrictive member 12 is rotated at an angular speed ω, the Coriolis force F is generated in the Y direction, which intersects at right angles with the X direction in which the giant magnetostrictive member 12 vibrates as well as with the rotation axis Z. This Coriolis force F changes the manner of vibration of the giant magnetostrictive member 12 in the Y direction, causing changes in the magnetic permeability or remnant magnetization of the giant magnetostrictive member 12. Accordingly, changes in the angular speed (o around the rotation axis in the Z direction can be detected by detecting these changes in the magnetic permeability or remnant magnetization as changes in the electromotive force of the GMR elements 20A and 20B. Changes in angular speed around other axes in the X and Y directions can also be detected by the similar principle.

With the gyro sensor 10 according to the exemplary embodiment of the present invention, angular speed changes are detected as changes in the magnetic permeability or remnant magnetization of a giant magnetostrictive member 12 caused by its deformation, which is brought about by the Coriolis force, using a giant magnetostrictive member 12 as a vibrating object, which is made of a giant magnetostrictive element, which produces a large vibration (displacement) and changes magnetic susceptibility largely in response to stress, whereby the sensor can have a small and simple structure and yet can detect angular changes with improved sensitivity. Moreover, with the use of the giant magnetostrictive element which responds quickly to stress, the angular speed changes are detected in a short time with improved response.

Furthermore, since the giant magnetostrictive member 12 is vibrated at is resonant frequency, its vibration amplitude is increased, whereby the detection sensitivity can be enhanced. In comparison to piezoelectric materials or silicone components which are widely used in conventional gyro sensors and have a sound speed of about 6000 m/s, the giant magnetostrictive element used in the present invention has a sound speed of about one third, 2000 m/s, and therefore the resonant frequency can be set lower than in conventional gyro sensors. Accordingly, the detection sensitivity can be further enhanced, and size reduction of the sensor can also be achieved.

The structure, shape and the like of the gyro sensor of the present invention should not be limited to those of the above-described exemplary embodiment of the gyro sensor 10. The minimum requirements are a giant magnetostrictive member made of a giant magnetostrictive element, a drive coil for vibrating the giant magnetostrictive member by controlling the intensity of a magnetic field applied to the giant magnetostrictive member, and detecting means for detecting changes in magnetic permeability or remnant magnetization of the giant magnetostrictive member.

While the changes in magnetic permeability or remnant magnetization of the giant magnetostrictive member 12 are detected as the changes in electromotive force of the GMR elements 20A and 20B in the above-described exemplary embodiment, the present invention is not limited thereto, and other magnetic resistance elements such as MR, TMR and the like may also be employed. Also, as with a gyro sensor 30 shown in FIG. 3, a detection coil 32 may be disposed to surround the giant magnetostrictive member 12, and changes in the magnetic permeability or remnant magnetization of the giant magnetostrictive member 12 may be detected as changes in inductance of the detection coil 32. Not to mention, changes in the magnetic permeability or remnant magnetization of the giant magnetostrictive member may be detected by some other detecting means.

While the gyro sensor 10 employs the giant magnetostrictive member 12 in the above-described exemplary embodiment, the present invention is not limited thereto, and a magnetostrictive member made of a magnetostrictive element may also be used.

### INDUSTRIAL APPLICABILITY

The advantages of the gyro sensor of the present invention are that it has a small and simple structure and yet is capable of detecting changes in angular speed with improved sensitivity.

1. A gyro sensor characterized by comprising:
a magnetostrictive member made of a magnetostrictive element;
a drive coil for vibrating the magnetostrictive member by controlling the intensity of a magnetic field applied to the magnetostrictive member; and
detecting means for detecting changes in magnetic permeability or remnant magnetization of the magnetostrictive member, wherein changes in angular speed around a rotation axis that is orthogonal to a direction in which the magnetostrictive member vibrates are detected as changes in magnetic permeability or remnant magnetization of the magnetostrictive member caused by deformation thereof, which is brought about by the Coriolis force.

2. The gyro sensor according to claim 1, wherein
the drive coil vibrates the magnetostrictive member at a resonant frequency.

3. The gyro sensor according to claim 1, wherein:
the detecting means includes a magnetic resistance element; and
the changes in magnetic permeability or remnant magnetization are detected as changes in electromotive force of the magnetic resistance element.

4. The gyro sensor according to claim 1, wherein;
the detecting means includes a detection coil surrounding the magnetostrictive member; and
the changes in magnetic permeability or remnant magnetization are detected as changes in inductance of the detection coil.

5. The gyro sensor according to claim 1, wherein:
a magnetic biasing magnet is tightly attached to one side of the magnetostrictive member; and
a soft magnetic member around which the drive coil is disposed is tightly attached to an opposite side of the magnetostrictive member.

6. The gyro sensor according to claim 1, wherein
the magnetostrictive member is a giant magnetostrictive member made of a giant magnetostrictive element.

7. The gyro sensor according to claim 2, wherein:
the detecting means includes a magnetic resistance element; and
the changes in magnetic permeability or remnant magnetization are detected as changes in electromotive force of the magnetic resistance element.

8. The gyro sensor according to claim 2, wherein;
the detecting means includes a detection coil surrounding the magnetostrictive member; and
the changes in magnetic permeability or remnant magnetization are detected as changes in inductance of the detection coil.

9. The gyro sensor according to claim 2, wherein:
a magnetic biasing magnet is tightly attached to one side of the magnetostrictive member; and
a soft magnetic member around which the drive coil is disposed is tightly attached to an opposite side of the magnetostrictive member.

10. The gyro sensor according to claim 3, wherein:
a magnetic biasing magnet is tightly attached to one side of the magnetostrictive member; and
a soft magnetic member around which the drive coil is disposed is tightly attached to an opposite side of the magnetostrictive member.

11. The gyro sensor according to claim 4, wherein:
a magnetic biasing magnet is tightly attached to one side of the magnetostrictive member; and
a soft magnetic member around which the drive coil is disposed is tightly attached to an opposite side of the magnetostrictive member.

12. The gyro sensor according to claim 2, wherein
the magnetostrictive member is a giant magnetostrictive member made of a giant magnetostrictive element.

13. The gyro sensor according to claim 3, wherein
the magnetostrictive member is a giant magnetostrictive member made of a giant magnetostrictive element.

14. The gyro sensor according to claim 5, wherein
the magnetostrictive member is a giant magnetostrictive member made of a giant magnetostrictive element.

15. The gyro sensor according to claim 7, wherein
the magnetostrictive member is a giant magnetostrictive member made of a giant magnetostrictive element.
